(19) United States
(12) Patent Application Publication
(10) Pub. No.: US 2015/0371276 A1
(43) Pub. Date: Dec. 24, 2015

(54) METHOD, SYSTEM AND APPLICATION FOR PROVIDING SECOND SCREEN ADVERTISMENTS AND REWARD OPPORTUNITIES TO A USER DEVICE

(71) Applicant: Perk.com Inc., Austin, TX (US)

(72) Inventors: Surojit Niyogi, Austin, TX (US); Adam A. Salamon, Austin, TX (US)

(21) Appl. No.: 14/663,943

(22) Filed: Mar. 20, 2015

Related U.S. Application Data
(60) Provisional application No. 62/013,918, filed on Jun. 18, 2014.

(51) Int. Cl. G06Q 30/02; G06F 3/0484

(52) U.S. Cl. CPC G06Q 30/0267; G06F 3/04842; G06Q 30/0207

(57) ABSTRACT

A system, method and application for displaying second screen advertisements and reward opportunities (e.g., loyalty points that can be exchanged for discount coupons, gift cards, cash, free items (digital or hard goods) or entertainment, etc.) when a user views and/or interacts with the second screen advertisements. The second screen advertisements are triggered by advertisements currently playing on a television (or other device capable of displaying television programs and advertisements) broadcasting a program selected by the user.

### CROSS REFERENCE TO RELATED APPLICATION

This application claims priority to U.S. Provisional Application Ser. No. 62/013,918, filed Jun. 18, 2014, the entirety of which is incorporated herein by reference.

### FIELD OF THE INVENTION

The disclosed embodiments relate to and provide for second screen advertisements, and reward opportunities (e.g., loyalty points that can be exchanged for discount coupons, gift cards, cash, free items (digital or hard goods) or entertainment, etc.) when the user views and/or interacts with the second screen advertisements, that are triggered by advertisements currently playing on a television (or other device capable of displaying television programs and advertisements).

### BACKGROUND

More and more people are spending time watching television (TV) with additional devices in their hands as they watch the programming on TV. This has caused branding rates for advertisers to plummet as people tune out their TV commercials in favor of turning to their mobile devices to check their email, play games, socialize, etc. In addition, digital video recording (DVR) has allowed viewers to fast forward through advertisements during their favorite programming making it harder and harder for advertisers to reach their intended audiences. This is largely because as technology advances, there are no incentives for a person to “stay tuned”.

Thus, there is a need and desire for a technique that provides a viewer with an incentive to pay attention to and view advertisements.

### SUMMARY

The disclosed principles seize an opportunity to provide users with an incentive to pay attention to advertisements that they would otherwise ignore. This can be done in a variety of ways including, but not limited to, providing an incentive to pay attention to their television set during the commercial break, or to have a synched experience on their second screen mobile device where a dual-commercial break plays in tandem with the commercial break on TV. This second screen commercial break can play while commercials play during TV advertisements, while the entertainment is playing, or when a user initiates a commercial break through their own control.

According to the principles disclosed herein, users are awarded with an incentive of any kind for having interacted with these advertisements rather than ignoring them. The second screen advertisements are triggered by advertisements currently playing on a television (or other device capable of displaying television programs and advertisements) broadcasting a program selected by the user.

### BRIEF DESCRIPTION OF THE DRAWING

FIGS. 1A-1G illustrate an example process flow of the disclosed method as implemented using a mobile phone.

FIG. 2 illustrates an example system comprising a system server for operating an embodiment of the method disclosed herein.

### DETAILED DESCRIPTION

In one embodiment, the disclosed system and method can be implemented using an application program that can be downloaded onto a mobile device (e.g., smartphone, PDA, tablet, music device or otherwise) and accessed by the user via the mobile device. The application program will cause the mobile device to interact with a system server to perform the method disclosed herein. In another embodiment, the disclosed system and method can be implemented via a website (e.g., “Perk.com”) operated by a server accessible by a user device (e.g., smartphone, PDA, tablet, laptop or personal computer) over the Internet or other network.

As used herein, the terms “second screen” or “second screen device” refer to the user device (e.g., smartphone, PDA, tablet, laptop or personal computer) interfacing with a system server to execute the method disclosed herein such that the user device displays on its screen advertisements and/or reward opportunities that are received from the system server (or other server) in response to the detection of advertisements playing on a television set (or similar device) within the vicinity (i.e., audible range) of the “second screen.” As used herein, the term “user” refers to a registered user of the disclosed system, method and application.

Users will be able to interface with the disclosed system and execute portions of the disclosed method via a cellular network connection, WiFi connection, and an Internet connection depending upon the second screen device. As will become apparent, the disclosed system and method can be accessed using social media such as e.g., Twitter, Facebook, and other social networking technology.

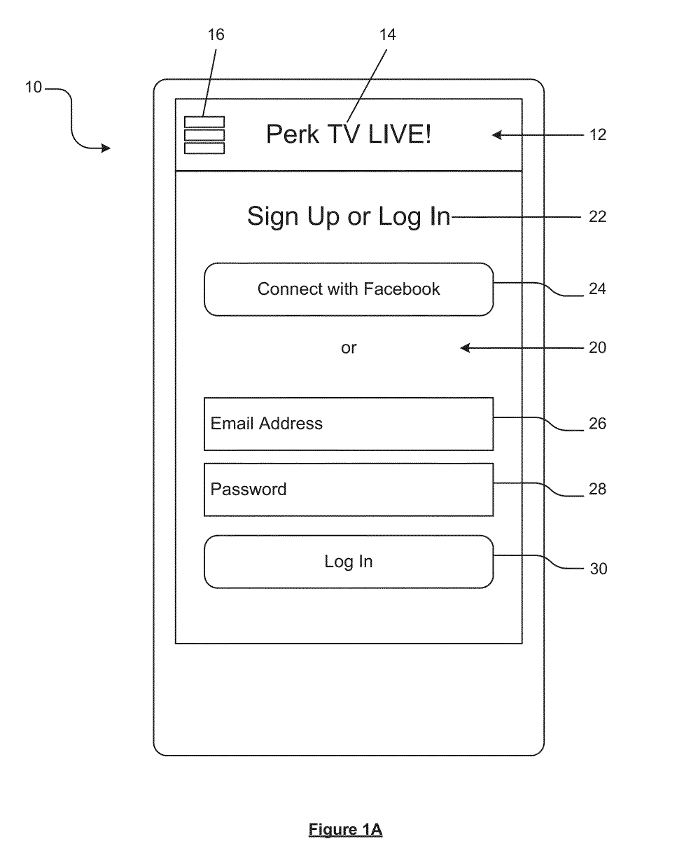

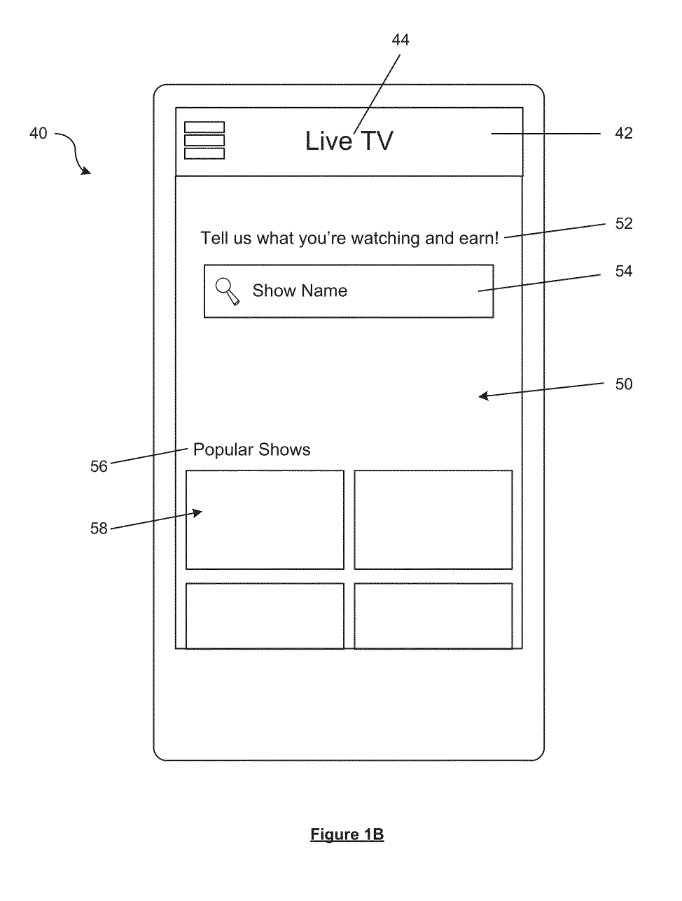

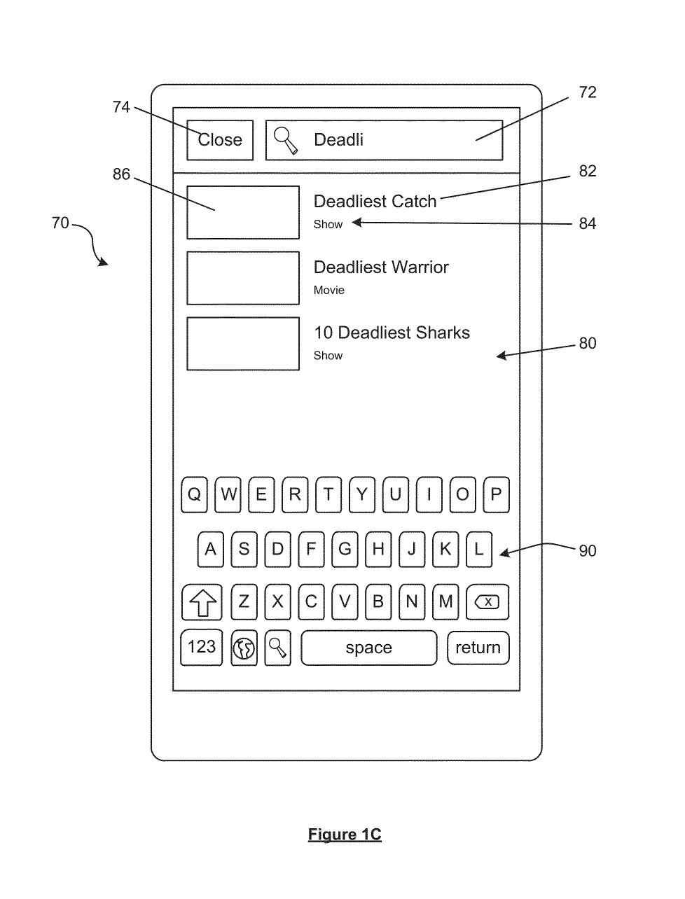

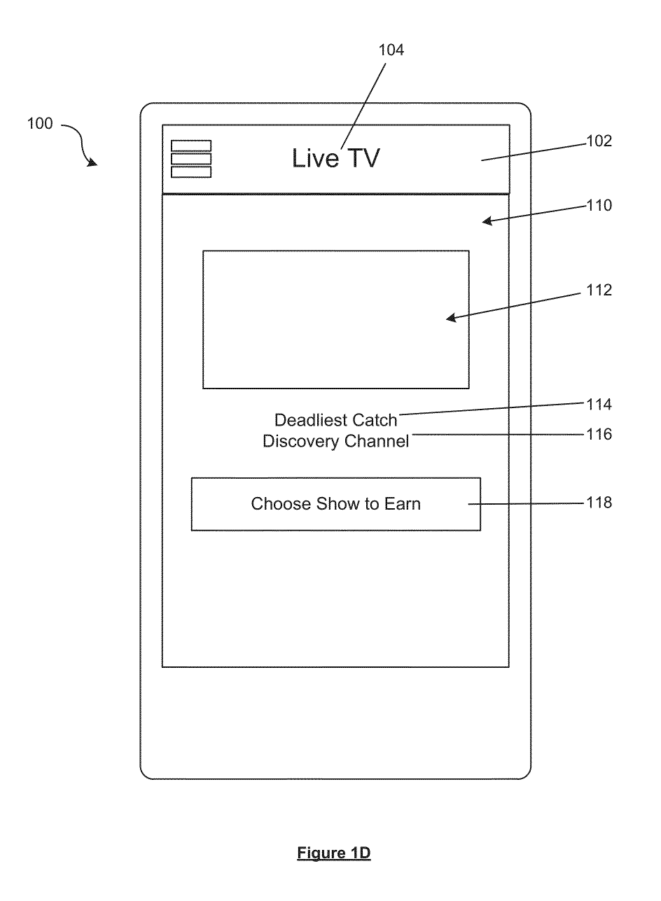

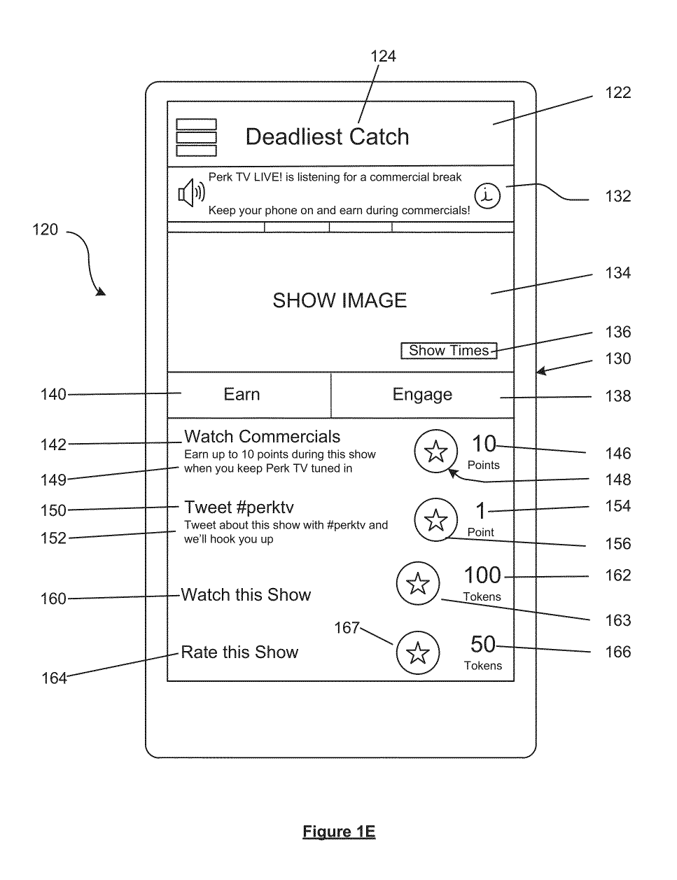

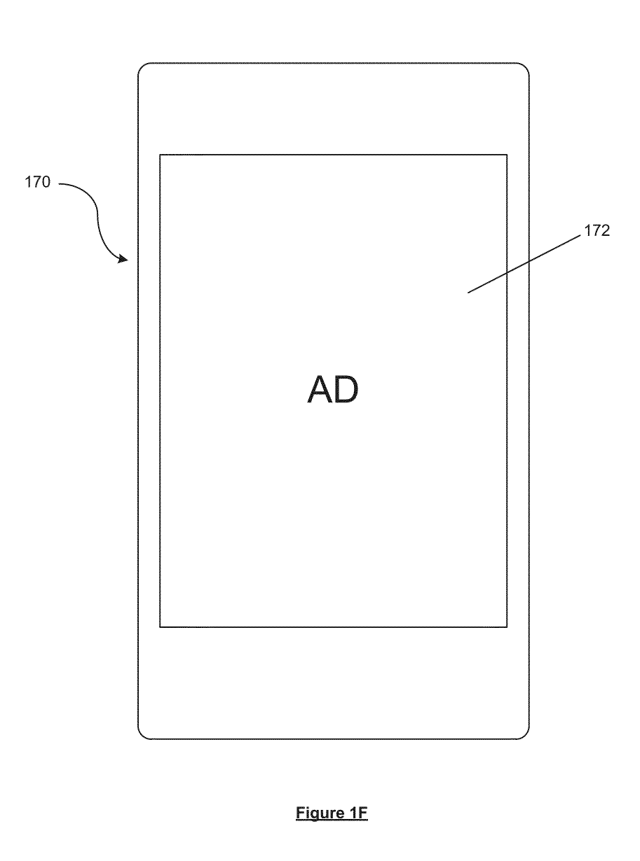

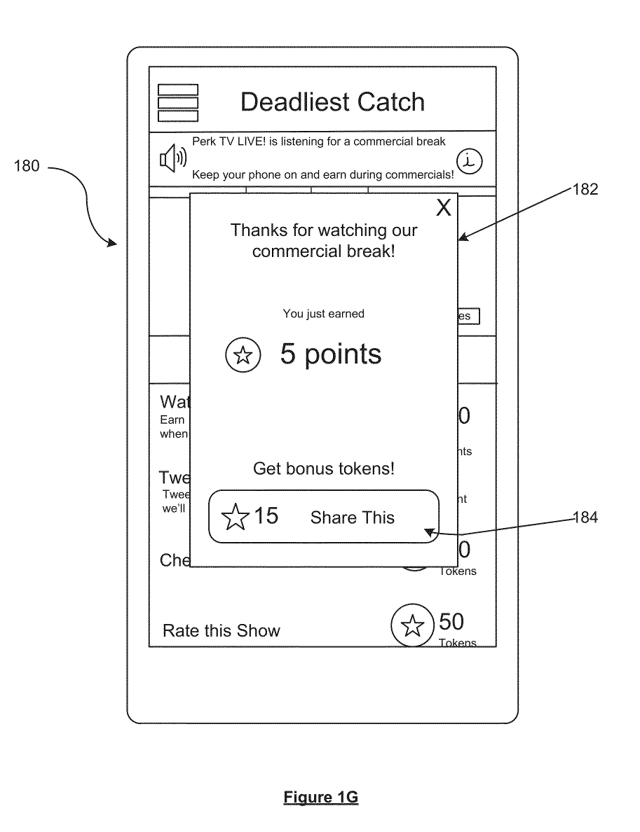

FIGS. 1A-1G illustrate an example process flow of the disclosed method as implemented using a mobile phone. As noted above, the method could utilize other mobile devices or typical computing devices such as a laptop or personal computer. All that is required is for the user device to be within the vicinity (i.e., audible range) of a television or other device (e.g., projector) so that the user device can detect, using automatic content recognition (ACR), advertisements running on the television (or other device).

According to an embodiment disclosed herein, the user would activate the application on its device and then log into the system from the user device. If the second screen device is a mobile device, laptop or personal computer the user could execute an application or program previously downloaded from the system and log in using that application/program; alternatively, the user can use any suitable device to log into the system via the Internet. FIGS. 1A-1G illustrate the user accessing the disclosed system and method via an application program running on a smartphone (i.e., the second screen device is a smartphone in the illustrated example). FIGS. 1A-1G are example pages that would display on the smartphone as the method is undergoing (i.e., once the user has activated the application on the smartphone). It should be appreciated that the example pages would look slightly different if the pages were displayed as part of a program or web page when the second screen device is another device (i.e., not a smartphone).

FIG. 1A illustrates a first page 10 allowing a user to log into the disclosed system. The illustrated page 10 includes an upper portion 12 having the text “Perk TV LIVE!” 104 indicating the type of page or application being run. In this instance, the page 10 is the Perk TV LIVE! sign-in page. The upper portion 12 also includes a universal menu selection 16 feature allowing the user of the device to access other features of the application or other applications on the device. The lower portion 20 of the example page 10 includes a “Sign Up or Log In” text field 22 and two example possibilities for logging into the system from a mobile device. The first option is to connect through a social media account (shown as Facebook in this example) via e.g., a “Connect with Facebook” selection option 24. It should be appreciated that option 24 could include the option to sign in from another form of social media account and is not limited to Facebook. The second option is for the user to supply a username (shown as an email address in this example) and password in the appropriate input fields 26, 28. Once the username and password fields 26, 28 have been filled in, the user selects the “Log In” selection option 30 to log into his/her account with the system.

As can be appreciated, the system/method disclosed herein will input and store usernames and passwords as part of an account setup procedure. The user's account is then used to maintain profile information, likes/dislikes, and or other information related to the particular user. The stored account information will also be used deliver targeted advertisements and reward opportunities to the user once the user logs into the system (as described below).

Referring to FIGS. 1B-1C, once logged in, the user “tells” the system what program it is or will be watching on e.g., a television. In the illustrated example shown in FIG. 1B, the page 40 includes an upper portion 42 comprising the text “Live TV” and a lower portion 50 allowing the user to manually enter the name of the program he/she will be watching. In the illustrated example, the lower portion 50 includes the text “Tell us what you're watching and earn!” 52 and an input box 54 in which the user can enter the name of the program. The example page 40 also includes a listing 56 of “Popular Shows” and graphics/text 58 listing the popular shows.

As shown in another example page 70 illustrated in FIG. 1C, as the user manually enters the name of the program an auto-fill procedure can be implemented such that the device displays program names as the user is typing on the user device. The illustrated page 70 includes a software keyboard 90 and an input box 72 containing what the user has typed while the lower portion 80 of the page provides a list of shows containing what the user has typed. A close option 74 is also provided. In the illustrated example, the user has entered “Deadli” in field 72 and the lower portion contains the title 82 of a program (i.e., “Deadliest Catch”), a description 84 of the program (i.e., “show”) and a graphic 86 associated with the program with names similar to what has been typed in. The graphic could be a still or video image associated with the program or some other type of graphic. The user may enter the entire name “Deadliest Catch” and/or select “Deadliest Catch” from the auto-fill list while or after typing the entire name of the program. Alternatively, or additionally, the user can select a program from a list or an electronic program guide (EPG) associated with the system. For example, the system could store and provide EPG data to the user device or, alternatively, the system could provide a list of programs that are collected and stored in a system database. The disclosed system and method could also maintain a list of programs that have already been played to account for the possibility that the user is now watching a program that was recorded on its DVR or other device. Additionally, a user could use a voice recognition system to tell the application which show they are watching

In the illustrated example, the user manually alerts the disclosed system and method that it wants to choose/acknowledge the selected program and start earning rewards. FIG. 1D illustrates an example page 100 for completing this operation. The page 100 includes an upper portion 102 with the title “Live TV” 104 and a lower portion 110 displaying information to the user to allow him/her to choose/acknowledge the program. The lower portion 110 of the page 100 can display an image/video 112 corresponding to the selected program, the program's title 114 (i.e., “Deadliest Catch”) and the channel 116 the program is being broadcast on (i.e., “Discovery Channel”). The user presses the “Choose Show to Earn” software button 118 to alert the system of his/her program choice. It should be appreciated that although the user chooses a program (e.g., “Deadliest Catch”), the rewards aspects of the disclosed system and method are based on/triggered by the advertisements that run during the selected program.

FIG. 1E displays a page 120 having an upper portion 122 displaying the text “Deadliest Catch” 124 to signify that the user has chosen to earn rewards during the broadcast of the “Deadliest Catch” program. Automatic content recognition technology is operating on the second screen device in the background and waiting for a commercial break on the television to begin. The lower portion 130 of the example page displays text 132 to inform the user that the system is “listening for a commercial break” (e.g., “Perk TV LIVE! is listening for a commercial break. Keep your phone on and earn during commercial!”). The automatic content recognition technology will respond to audio that is picked up by the second screen device's microphone. Any type of hardware, device, circuitry, software, or combination thereof, can be used to implement the automatic content recognition required to implement the disclosed system and method. It should be appreciated that the automatic content recognition technology (including the microphone) could be activated as soon as the user activates the application on the user device or logs into the system, this way the technology will be ready as soon as the user chooses a program. Alternatively, the automatic content recognition technology can be activated once the user chooses the program. In one embodiment, advertisements are pre-screened (the program content may also be pre-screened). The audio is captured in real-time (sometimes before it even gets broadcast down to the end-user). The automatic content recognition technology then tells the system's client/mobile device to prepare the application to show a commercial break. This allows the disclosed system to know when to deliver advertisements to the user in almost real-time.

The example page 120 also illustrates software selection tabs to “Earn” rewards (tab 140) or to “Engage” components of the disclosed system and method (tab 138). FIG. 1E illustrates example rewards associated with the “Earn” tab. For example, there is a first reward 142 labeled “Watch Commercials”, a description of how to obtain the first reward 144, the number of reward points 146 and a graphic 148 associated with the first reward. There is a second reward 150 labeled “Tweet #perktv”, a description of how to obtain the second reward 152, the number of reward points 154 and a graphic 156 associated with the second reward. There is a third reward 160 labeled “Watch this show”, the number of reward points 162 and a graphic 163 associated with the third reward. There is a fourth reward 164 labeled “Rate this show”, the number of reward points 166 and a graphic 167 associated with the fourth reward. An image 134 and “Show Times” software selection button 136 may also be displayed to plan out when the user should be earning rewards and tuning in. For example, a user could create an alert to notify them when a show was starting.

When the user's device detects that a commercial break starts on the nearby television, the disclosed system and method cause a commercial break to begin on the user device using e.g., advertisements selected by the disclosed system and method. FIG. 1F shows an example page 170 illustrating the playback of an advertisement 172 on the second screen device. The “second screen” commercials are delivered to the user device via the cellular network or Internet and run by the application/program running on the user's device. These advertisements are received from e.g., an ad-server associated with or part of the disclosed system's server. Commercials are displayed using any of combination of user profile information, including the user's device, brand/carrier/device type, location of the user, advertisement and/or program content on the television, purchase behavior on and offline tied to the user's account.

Once the commercial break ends, the user is rewarded for tuning into the “second screen” commercials instead of viewing the commercials on the TV. FIG. 1G illustrates an example page 180 showing a reward notification 182. The user can also be rewarded for sharing the experience (shown in FIG. 1G with a “Share This” selection 184) and/or interacting with the second screen advertisement (as illustrated in FIG. 1E).

As can be appreciated, once the television program comes back on, the disclosed method reverts to waiting for the next commercial break, where the disclosed second screen advertisement and rewards steps are repeated upon detection of audio associated with an advertisement/commercial playing on the television. It should be appreciated that the second screen advertisements may be tailored for the specific user based on many factors associated with the user and his/her account. The second screen advertisements could be advertisements associated with advertisers registered with the disclosed system and in one embodiment, these registered advertisements can be sent to the user device when the automatic content recognition technology detects that a competitors advertisement is running on the television (providing the user the ability to see advertisements and rewards for advertisers affiliated with the disclosed system).

Accordingly, the disclosed system and method provide at least the following, triggered by automatic content recognition of television advertisements, which does not occur in any of today's systems and devices:

(1) second screen commercials on mobile or other user device(s) using automatic content recognition to recognize when a commercial break starts;

(2) second screen commercials on mobile or other user device(s) using automatic content recognition with incentives for tuning into advertisements associated with the disclosed system;

(3) second screen synched commercials with rewards (i.e., playing the same advertisement that is playing on the television on the user device at the same exact time and rewarding the user for watching the advertisement on the user device);

(4) second screen competitive commercials (e.g., playing an advertisement of an advertiser registered with the disclosed system on the mobile device at the exact same time that a competitor's advertisement is playing on the television);

(5) using automatic content recognition to anticipate when a commercial break is starting so that advertisements can be synchronized (e.g., by listening for the start of an advertisement on a separate device that retrieves the advertisement faster than live cable programming);

(6) personalizing second screen commercials targeted to the user based on profile data;

(7) always-on automatic content recognition of television advertisements as opposed to user-initiated automatic content recognition; and

(8) re-targeting users based on advertisements/commercials viewed (i.e., by attaching the viewed advertisement to the user's device ID, email address, IP address, etc. Retargeting is targeted both through the application, additional advertisements, push notifications, email, direct mail, or in other applications by advertising and targeting device ID).

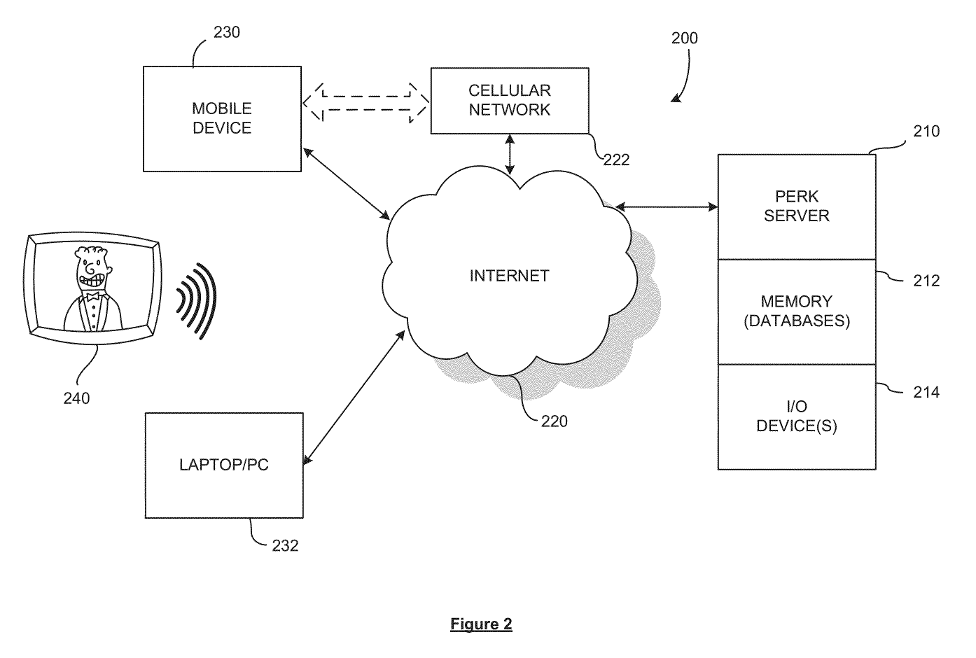

In one embodiment, the above described system is implemented in software (i.e., computer instructions) that are stored in a computer readable memory and executed by a processor. FIG. 2 illustrates an example system 200 comprising a “Perk TV” system server 210 for operating an embodiment of the method disclosed herein. The server 210 includes or is connected to a memory 212 for storing computer instructions required to implement the method described herein and to store the various databases, user information and login/account verification algorithms used during the above-described processes as well as the advertisements delivered to the user's device(s). The system 200 includes a database (shown as part of memory 212 in the illustrated example) for user accounts, loyalty points, and profile information as well as a database of advertisers and commercials that allows the system/method to provide the most personalized commercial to the user based on the information maintained by the system.

The server 210 can be accessed over a wired or wireless network (shown as the Internet in this example) 220. User devices include a mobile device 230 and a laptop/PC 232 that connect to the server 210 via the Internet/network 220 or a cellular network 222. The user device(s) will be in the vicinity (i.e., audible range) of a television (or similar device) 240 displaying a program and commercials/advertisements as described above. The server 210 can include input/output devices 214 such as displays, scanners, printers, etc.

It should be appreciated that the disclosed system, method and application should not be limited solely to detecting television advertisements. That is, the disclosed principles may be applied to any communication medium that includes advertisements including e.g., radio and Internet programming with just a few modifications. The second screen device will need to be within audible range of the radio or Internet programming (in the same way the device would need to be within audible range of a television). The user can choose the program by e.g., type of station (e.g., classic rock, alternative, classical, news, sports, etc.) or Internet programming to alert the disclosed system to the programming (again, in the same/similar way that the device alerts the system to a television program). Once the system and method has the user's choice, advertisements and rewards can be transmitted to the second screen device (in the same manner discussed above with respect to FIGS. 1A-1G and 2) when advertisements/commercials are played on the radio or device outputting the Internet programming (e.g., any device capable of connecting to the Internet and outputting a program from the Internet), including real time programming or recorded programming such as a podcast.

The foregoing examples are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A method of providing second screen advertisements to a user device, said method comprising:
inputting a program selection at the user device to activate the use of second screen advertisements at the user device during presentation of the program;
detecting at the user device that the presentation of the program on another device is about to initiate a commercial break; and
playing the second screen advertisements at the user device during the commercial break.

2. The method of claim 1, wherein the detecting step comprises:
detecting audio from the another device; and
using audible automatic content recognition to determine when the detected audio is associated with an upcoming commercial break during the program.

3. The method of claim 2, wherein the audible automatic content recognition is automatically activated and run as a background process on the user device.

4. The method of claim 1, wherein the user device is a mobile phone and the another device is a television.

5. The method of claim 1, wherein the user device is a computer and the another device is a television.

6. The method of claim 1, wherein the second screen advertisements are based on a profile of a user of the user device.

7. The method of claim 1, wherein the second screen advertisements are the same as advertisements played during the commercial break on the another device.

8. The method of claim 1, wherein the second screen advertisements are competitor advertisements to the advertisements played during the commercial break on the another device.

9. The method of claim 1, further comprising:
displaying a notification that a user of the user device has earned a reward for observing the second screen advertisements.

10. The method of claim 9, wherein the reward is based on a level of interaction of the user during the second screen advertisements.

11. A method of providing second advertisements and rewards to a user, said method comprising:
inputting a program selection at the user device to activate the use of second screen advertisements at the user device during presentation of the program;
inputting a user level of interaction associated with the program or second screen advertisements;
detecting at the user device that the presentation of the program on another device is about to initiate a commercial break;
playing the second screen advertisements at the user device during the commercial break; and
displaying a notification that a user of the user device has earned a reward for interacting with the second screen advertisements.

12. The method of claim 11, wherein the user level of interaction comprises one of watching the second screen advertisements, rating the program, or commenting on the program using social media.

13. The method of claim 11, wherein the detecting step comprises:
detecting audio from the another device; and
using audible automatic content recognition to determine when the detected audio is associated with an upcoming commercial break during the program.

14. The method of claim 13, wherein the audible automatic content recognition is automatically activated and run as a background process on the user device.

15. The method of claim 11, wherein the user device is a mobile phone and the another device is a television.

16. The method of claim 11, wherein the user device is a computer and the another device is a television.

17. The method of claim 11, wherein the second screen advertisements are based on a profile of a user of the user device.

18. The method of claim 11, wherein the second screen advertisements are the same as advertisements played during the commercial break on the another device.

19. The method of claim 11, wherein the second screen advertisements are competitor advertisements to the advertisements played during the commercial break on the another device.

20. A system for providing second screen advertisements to a user device, said system comprising:
a server adapted to:
input a user program selection from the user device to activate the use of second screen advertisements at the user device during presentation of the program;
transmit the second screen advertisements to the user device; and
compute a reward for a user associated with the user device.

21. The system of claim 20, wherein the reward is based on a level of interaction of a user of the user device during the second screen advertisements.

22. The system of claim 20, further comprising a database for storing a user profile associated with a user of the user device, and wherein the second screen advertisements are based on the profile of the user of the user device.

23. The system of claim 20, wherein the second screen advertisements are the same as advertisements played during the commercial break on the another device.

24. The system of claim 20, wherein the second screen advertisements are competitor advertisements to the advertisements played during the commercial break on the another device.
